(19) United States
(12) Patent Application Publication
(10) Pub. No.: US 2014/0013148 A1
(43) Pub. Date: Jan. 9, 2014

(54) BARRIER SYNCHRONIZATION METHOD, BARRIER SYNCHRONIZATION APPARATUS AND ARITHMETIC PROCESSING UNIT

(71) Applicant: FUJITSU LIMITED, Kawasaki-shi (JP)

(72) Inventor: Koken SHIMIZUNO, Kawasaki (JP)

(73) Assignee: FUJITSU LIMITED, Kawasaki-shi (JP)

(21) Appl. No.: 14/024,164

(22) Filed: Sep. 11, 2013

Related U.S. Application Data
(63) Continuation of application No. PCT/JP2011/001716, filed on Mar. 23, 2011.

(51) Int. Cl. G06F 1/12

(52) U.S. Cl. CPC G06F 1/12
USPC 713/375

(57) ABSTRACT

A plurality of barrier blades, a barrier blade identification information storage unit, and a barrier blade identification information selection unit are provided. The plurality of barrier blades synchronize, using a synchronization address set for a plurality of arithmetic processing units, the plurality of arithmetic processing units. The barrier blade identification information storage unit holds barrier blade identification information to identify the barrier blade corresponding to synchronization address identification information to identify the synchronization address, for each of the plurality of arithmetic processing units. When synchronization address identification information is input, the barrier blade identification information selection unit selects and outputs barrier blade identification information corresponding to the input synchronization address identification information, among barrier blade identification information held by the barrier blade identification information storage unit.

### CROSS-REFERENCE TO RELATED APPLICATIONS

This application is a continuation application of International PCT Application No. PCT/JP2011/001716 which was filed on Mar. 23, 2011.

### FIELD

The embodiments discussed herein are related to a barrier synchronization method, a barrier synchronization apparatus and an arithmetic processing apparatus.

### BACKGROUND

Speeding and expansion of the capacity of the processing is required for a computer system, and to realize them, a distributed processing technique by a plurality of processors is used. In order to satisfy the respective requirements for the speeding up of the processing speed and the expansion of the processing capacity, distributed processing with a good efficiency by a plurality of processors is required.

In barrier synchronization, grouping of a plurality of processors into a plurality of synchronization groups is performed, and processing is executed in units of the groups. That is, while a processor belonging to one synchronization processor is executing a process, waiting for the processing is performed, and after the processing of all the processors belonging to the same synchronization group ends, the respective processors are moved to the execution of the next process.

Regarding this barrier synchronization method, assigning a plurality of threads to the respective processors and making them execute a multi-thread processing, setting groups in a hierarchical structure for the plurality of thread, and providing barrier synchronization for each group have been known.

### Prior Art Document

Patent document 1 Japanese Laid-open Patent Publication No. 2006-259821

As an arithmetic processing apparatus, a multicore processor on which a plurality of processor cores are mounted, has been commercialized as a product. The respective processor cores implemented on the multicore processors includes various unit, register, cache memory and the like to perform decoding and execution of an instruction. In a multicore processor on which such processor cores are mounted, the respective processor cores become the target to assign the synchronization group.

In the respective processor cores, each ASI (Address Space Identifier) set for a plurality of Address Space Identifier register that are accessible from software used for barrier synchronization is referred to as an “window”. That is, the window is a plurality of addresses set for the respective processors at the time of writing of BST (Barrier Status bit) in barrier synchronization. In a barrier synchronization apparatus, a Barrier Blade (BB) corresponding to the window (ASI address) used for barrier synchronization is provided. The BB assigns a synchronization group to each window set for the processor core, and stores the status of the synchronization group. For this reason, to each ASI register that holds each window, each BB is physically connected to, and an arbitrary BB may be freely assigned to an arbitrary window. However, when the number of cores increases, in addition to the increase in the resource simply corresponding to the number of cores, the resource per one processor core increases according to the number of BBs, windows, and the number of physical connections also increases. As a result, the physical resource such as the selector, wiring and the like required for window control increases exponentially, occupying a large area in the chip of the multicore processor and increasing the power consumption.

The physical resource according to the selector mentioned above is given, at a rough estimate, as

Quantitative resource=the number of BBs×the number of windows×the number of cores (1)

and its amount is enormous.

There has been a trend of expansion of the whole shared cache part is due to the increase in the number of cores in recent years, and according to this, there is an increasing need for power saving as well.

### SUMMARY

A barrier synchronization method, a barrier synchronization apparatus and an arithmetic processing apparatus disclosed herein include a plurality of barrier blades, a barrier blade identification information storage unit, and a barrier blade identification information selection unit The plurality of barrier blades synchronize, using a synchronization address set for a plurality of arithmetic processing units, the plurality of arithmetic processing units. The barrier blade identification information storage unit holds barrier blade identification information to identify the barrier blade corresponding to synchronization address identification information to identify the synchronization address, for each of the plurality of arithmetic processing units. When synchronization address identification information is input, the barrier blade identification information selection unit selects and outputs barrier blade identification information corresponding to the input synchronization address identification information, among barrier blade identification information held by the barrier blade identification information storage unit.

According to the barrier synchronization method, the barrier synchronization apparatus, and the arithmetic processing apparatus described herein, one of the following effects may be obtained.

(1) The specification range of the barrier blade is determined by a plurality of categorized barrier blades and a window (ASI address) classified by the category of the barrier blade and used for barrier synchronization, and the barrier blade may be selected within the range. Therefore, physical resource such as the selector and the connection line and the like may be reduced, without hindering the barrier synchronization function.

(2) The increase in physical resource such as the selector and the connection line and the like with respect to the increase in the arithmetic processing unit such as the processor core may be curbed.

(3) According to the reduction in physical resource, the power consumption is curbed.

Then, other objects, characteristics and advantages of the present invention will be further apparent by referring to the appended drawings and the respective embodiments.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed

### BRIEF DESCRIPTION OF DRAWINGS

FIG. 1 is a diagram illustrating a barrier processing unit according to the first embodiment.

FIG. 2 is a flowchart illustrating an example of a distinguishing process procedure of a barrier blade and a window.

FIG. 3 is a flowchart illustrating an example of a setting process procedure of a window and a barrier blade.

FIG. 4 is a diagram illustrating a configuration example of a multicore processor according to the second embodiment.

FIG. 5 is a diagram illustrating a configuration example of the barrier processing unit.

FIG. 6 is a diagram illustrating a configuration example of a window storage unit.

FIGS. 7A and 7B are diagrams illustrating a configuration example of first and second BBs for synchronization.

FIG. 8 is a diagram illustrating a configuration example of input/output of the barrier processing unit.

FIG. 9 is a diagram illustrating a configuration example of a window register input control unit.

FIG. 10 is a diagram illustrating a configuration example of a barrier synchronization input control unit.

FIG. 11 is a diagram illustrating a configuration example of an output control unit.

FIG. 12 is a flowchart illustrating an example of a process procedure of barrier synchronization control.

FIG. 13 is a diagram illustrating the connection relationship of the window and the first and second BBs for synchronization.

FIG. 14 is a diagram illustrating a variation example of a multicore processor.

FIG. 15 is a diagram illustrating a configuration example of a computer node according to the third embodiment.

FIG. 16 is a diagram illustrating a configuration example of a computer system.

FIG. 17 is a diagram illustrating the connection relationship of the window and the BB for synchronization according to a comparison example.

FIG. 18 is a diagram illustrating a status information conversion unit according to a comparison example.

### DESCRIPTION OF EMBODIMENTS

### First Embodiment

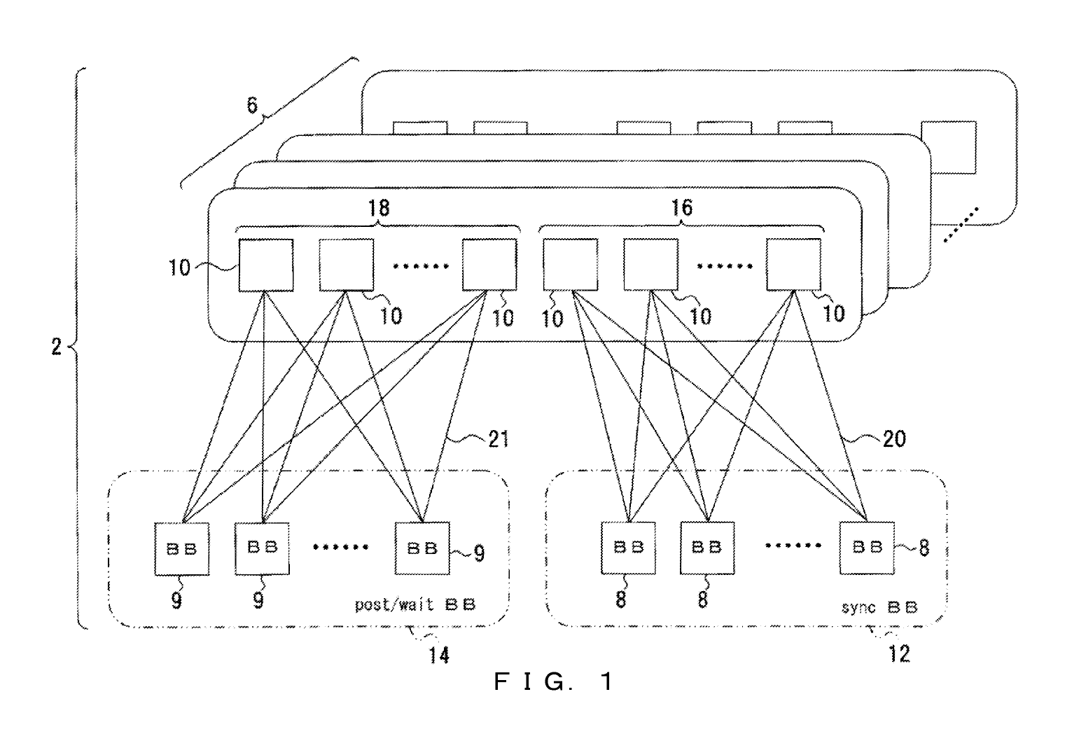

Regarding the first embodiment, FIG. 1 is referred to FIG. 1 illustrates a barrier processing unit. The configuration illustrated in the drawing is an example, and the present invention is not limited to such a configuration.

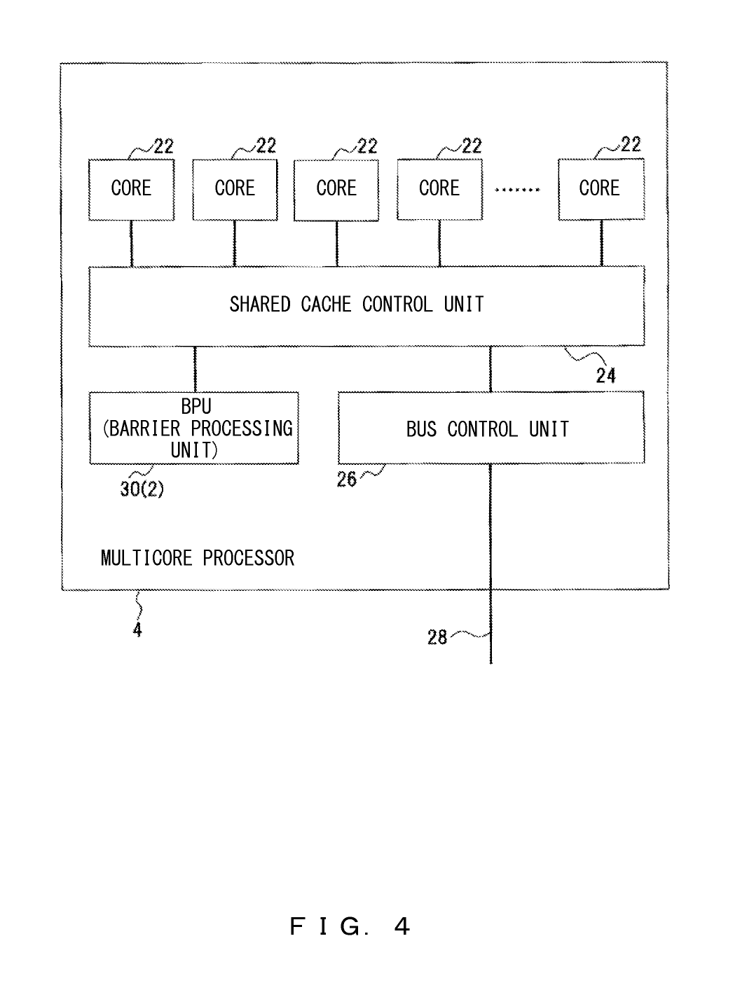

The barrier processing unit (BPU) 2 is an example of the disclosed barrier synchronization method and the barrier synchronization apparatus, and is used for a multicore processor described later (for example, the multicore processor 4 illustrated in FIG. 4). In the barrier processing unit 2 illustrated in FIG. 1, a window storage unit 6 and a plurality of barrier blades (hereinafter, referred to as the “BB”) 8, 9 are provided.

The window storage unit 6 is a means to store information of the window (ASI address) categorized based on the categories of the plurality of BBs 8, 9. That is, the window storage unit 6 is an example of a barrier blade identification information storage unit that holds barrier synchronization identification information to identify the barrier blade corresponding to synchronization address identification information to identify the synchronization address for every plurality of arithmetic processing units (for example, processor cores). The window is an address used for a single or plural barrier synchronization (that is, synchronization address) set for a plurality of cores (cores 22 in FIG. 4). The window storage unit 6 includes a plurality of storage units 10, and each storage unit 10 corresponds to a window set for each processor core (hereinafter, referred to simply as the “core”). That is, the window storage unit 6 is a conversion means of window information (for example, a window number) and identification information to identify the BBs 8, 9 (a BB number). Each storage unit 10 stores identification information to identify BBs 8, 9 and its accompanying information. Each storage unit 10 is composed of a register for example. The identification information to identify the BBs 8, 9 is the BB numbers to identify the respective BBs 8, 9. The accompanying information is information to represent whether or not the BBs 8, 9 specified by the identification information are valid. That is, each storage unit 10 is a resource to store the BB number assigned to the window and the accompanying information described above. Therefore, the window storage unit 5 stores which BB 8 or BB 9 has been assigned for each window of each core, and to freely assign the BBs 8, 9 by software. That is, the usage of barrier synchronization becomes available on the condition that the BBs 8, 9 are assigned to the window being an address used for barrier synchronization.

The respective BBs 8, 9 are an example of the barrier blade being the resource for barrier synchronization and uses the synchronization address (window) set for a plurality of cores to synchronize the plurality of cores. The respective BBs 8, 9 divides the synchronization groups of the barrier and store the status of the synchronization group inside. Each BB 8 is a BB for synchronization between a plurality of cores (hereinafter, referred to as the “syncBB”), and each BB 9 is a BB for synchronization between two cores (hereinafter, referred to as the “post/wait BB or “p/wBB”). That is, as described above, the BB 8 and the BB 9 has purposes that are different from each other, and are equipped with a configuration according to the purpose. Therefore, to categorize the respective BBs 8, 9 into two kinds according to the purpose, they are categorized by grouping into a syncBB group 12 as a first barrier blade, and the p/wBB group 14 as a second barrier blade.

To each storage unit 10 of the window storage unit 6, the BB 8 or BB 9 is connected. In the barrier processing unit 2 illustrated in FIG. 1, a plurality of storage unit 10 corresponding to the syncBB group 12 is set as a first storage unit group 16. and a plurality of storage units 10 corresponding to the p/wBB group 14 are set as a second storage unit group 18. That is, the plurality of storage unit 10 of the window storage unit 6 are classified corresponding to the syncBB group 12 and the p/wBB group 14 of the plurality of BBs 8, 9 categorized by the purpose. That is, the window storage unit 6 performs grouping of barrier synchronization identification information based on the barrier blades of each group, that is, the BBs 8, 9 and holds it, as a barrier blade identification information storage unit.

To each storage unit 10 belonging to the storage unit group 16, each BB 8 of the syncBB 12 is connected by a first connection line being physical resource. In addition, to each storage unit 10 belonging to the second storage group unit 18, each BB 9 of the p/wBB 14 is connected in a similar manner by a second connection line 21 being physical resource. These connections are fixed connection relationship, and correspondence relationship is provided respectively for the BBs 8, 9 with different purposes. That is, the BBs 8, 9 are categorized according to the purpose, and since each window is classified corresponding to it, the plurality of storage units 10 correspond to the classified window. Therefore, the range in which the assignment between the storage unit 10 and the BBs 8, 9 that are not in correspondence relationship is available (specification available range) is physically limited. Therefore, to the storage unit 10 of the storage unit group 16 side, the BB 9 of the p/wBB 14 side is never assigned, and to the storage unit 10 of the storage group 18 side, the BB 8 of the syncBB 12 side is never assigned.

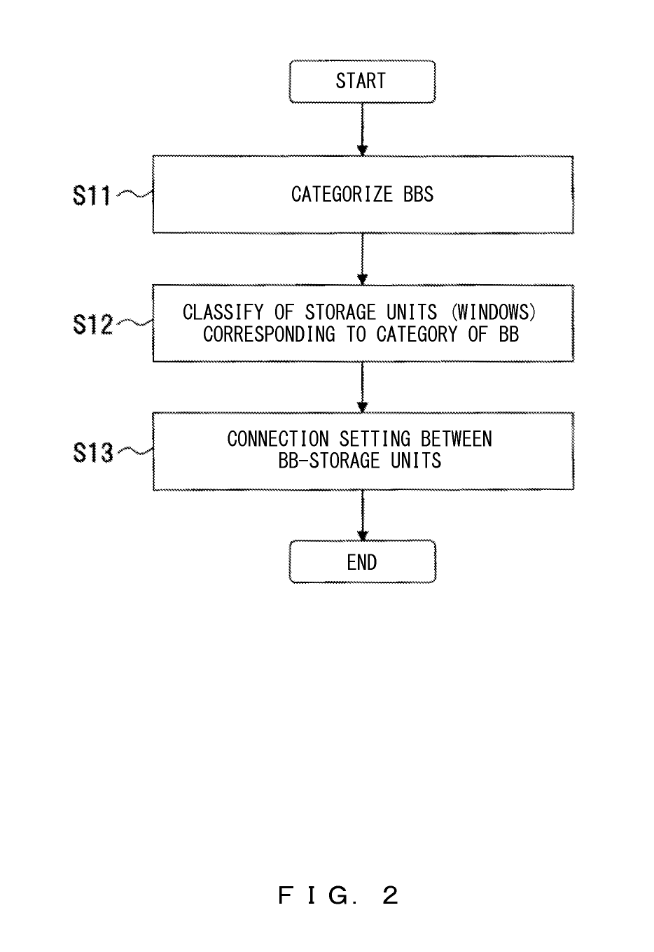

Regarding the categorization of the BBs 8, 9 and the classification of the storage unit 10 by the purpose described above, FIG. 2 is referred to. FIG. 2 illustrates the process procedure of the BB 8 and the storage unit 10.

The process procedure illustrated in FIG. 2 is an example of the barrier synchronization method disclosed herein, and categorizes the BBs 8, 9 by the purpose (step S11). In the categorization as an example, grouping of the BBs 9, 9, are performed by the purpose whether it is for synchronization between a plurality of cores or for synchronization between two cores, as described above.

As described above, to the BBs 8, 9 categorized by the purpose, each storage unit 10 of the window storage unit 6 is associated, to classify each storage unit 10 (step S12).

The BB 8 on the syncBB 12 side categorized by the purpose as described above and the storage unit 10 of the first storage unit group 16 are connected (step S13), and the BB 9 of the p/wBB 14 and the storage unit 10 of the second storage unit group 18 are connected (step S13). Such connection setting is fixed, and the range in which assignment of the BB 8, 9 to the window is available is limited.

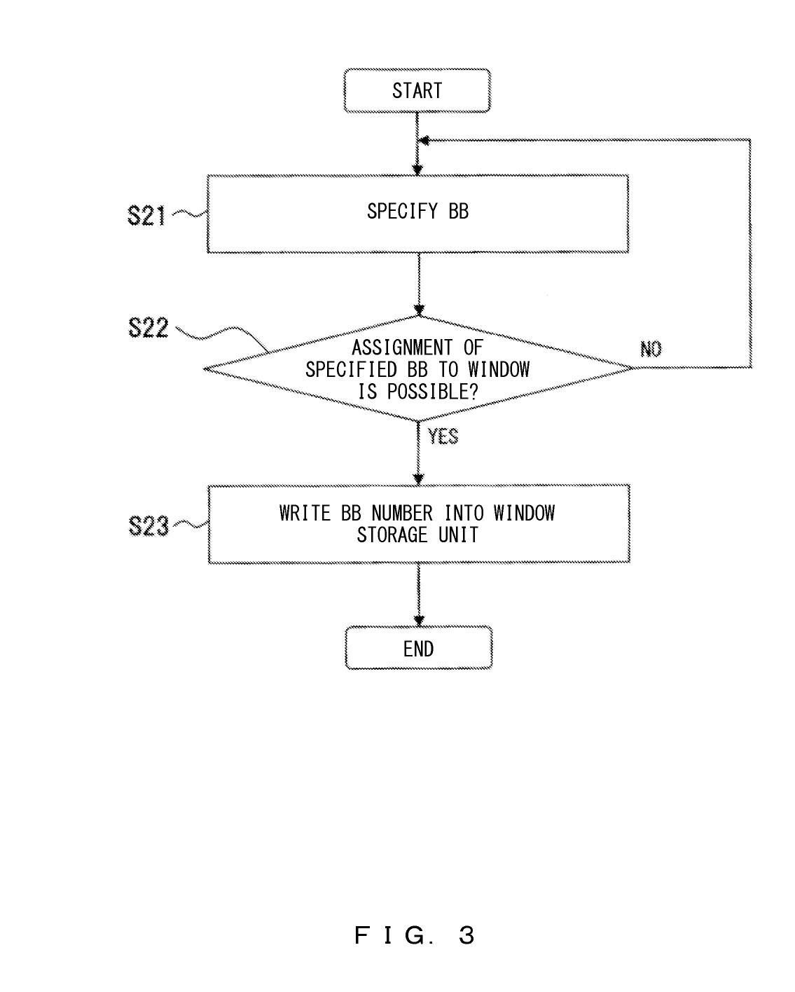

Regarding the assignment of the BBs 8, 9 to the window, FIG. 3 is referred to. FIG. 3 illustrates the process procedure of the BB to the window.

In the process procedure illustrated in FIG. 3, for the setting of synchronization, the BB 8 or the BB 9 is specified (step S21), and whether setting of the specified BB 8 or BB 9 to the window is possible is judged (step S22). That is, whether writing of the specified BB 8, 9 into the storage unit 10 of the window storage unit 6 is possible is judged. When writing is not possible, return to step S21 is performed.

When the writing of the specified BB 8 or BB 9 into the storage unit 10 of the window storage unit 6 is possible (YES in step S22), the writing of the BB number being the identification information of the BB 8 or BB 9 into the window storage unit 6 is performed (step S23).

By the setting of the correspondence relationship as described above, the BB 8, 9 is assigned to the window of each core, and in each storage unit 10 of the window storage unit 6, the BB number is stored as information representing which of the BBs 8, 9 has been assigned. The assignment of the BBs 8, 9 to the window enables the start of barrier synchronization.

By such a configuration, each storage unit 10 of the window storage unit 6 corresponding to each window set for the core of the processor is classified corresponding to the category of the BBs 8, 9, and physically limited to one of the BBs 8, 9 set for the window. That is, in the storage unit 10 that is not connected to any of the BBs by the connection line 20 or the connection line 21, the BB number representing the BB is never stored, and the BB that does not have any correspondence relationship with the distinguished window is excluded from the selection target.

Therefore, in this embodiment, the BB assigned to the window is physically selected from one of the BB 8 or the BB 9, and is selected from the BB 8 or BB 9 in the specification available area. By such setting, the physical resource may be reduced without hindering the barrier synchronization function. That is, a single window or a plurality of windows are set for each core, and even when the number of the windows increase according to the number of cores, the increase in physical resource such as the connection line 20 and the like described above is suppressed. The amount of reduction of the physical resource is,

the amount of reduction of the physical resource=the amount of reduction per core×the number of cores. (2).

That is, the amount of reduction of the physical resource exponentially increases according to the increase in the number of cores in the multicore processor, making its reduction effect prominent.

### Second Embodiment

Regarding the second embodiment, FIG. 4 is referred to FIG. 4 illustrates the configuration of a multiprocessor.

The configuration illustrated in FIG. 4 is an example, and the present invention is not limited to such a configuration.

The multicore processor 4 (hereinafter, simply referred to as the “processor 4”) is an example of an arithmetic processing apparatus, and an example of the barrier synchronization method, the barrier synchronization apparatus and the arithmetic processing apparatus disclosed herein. The processor 4 is a processor that is implemented on an LSI (Large Scale Integration), for example.

The processor 4 illustrated in FIG. 4 includes a plurality of processor cores (hereinafter, simply referred to as the “core”) 22. Each core 22 includes various unit, register, cache memory and the like to perform decoding and execution of an instruction. For each core 22, a window (ASI address) to use for a single synchronization or a plurality of barrier synchronizations described above is set.

To each core 22, a system bus 28 is connected via a shared cache control unit 24 and a bus control unit 26, and a barrier processing unit (BPU) 30 is connected. By such a configuration, each core 22 accesses the bus control unit 26 or the BPU 30, or performs transmission/reception of data. The barrier processing unit 30 is an example of the barrier synchronization apparatus disclosed herein, and for the processor 4 illustrated in FIG. 4, the barrier synchronization apparatus disclosed herein is configured.

The barrier processing unit 30 is a control unit for realizing barrier synchronization of the same synchronization group between the respective cores 22 inside the processor 4. In the barrier processing unit 30, data transmission/reception to/from outside the processor 4 is avoided to realize barrier synchronization, and the barrier synchronization is realized inside the processor 4. For this reason, data transmission/reception at a lower speed compared with the processing speed in the processor 4 is avoided, to speedup the barrier synchronization.

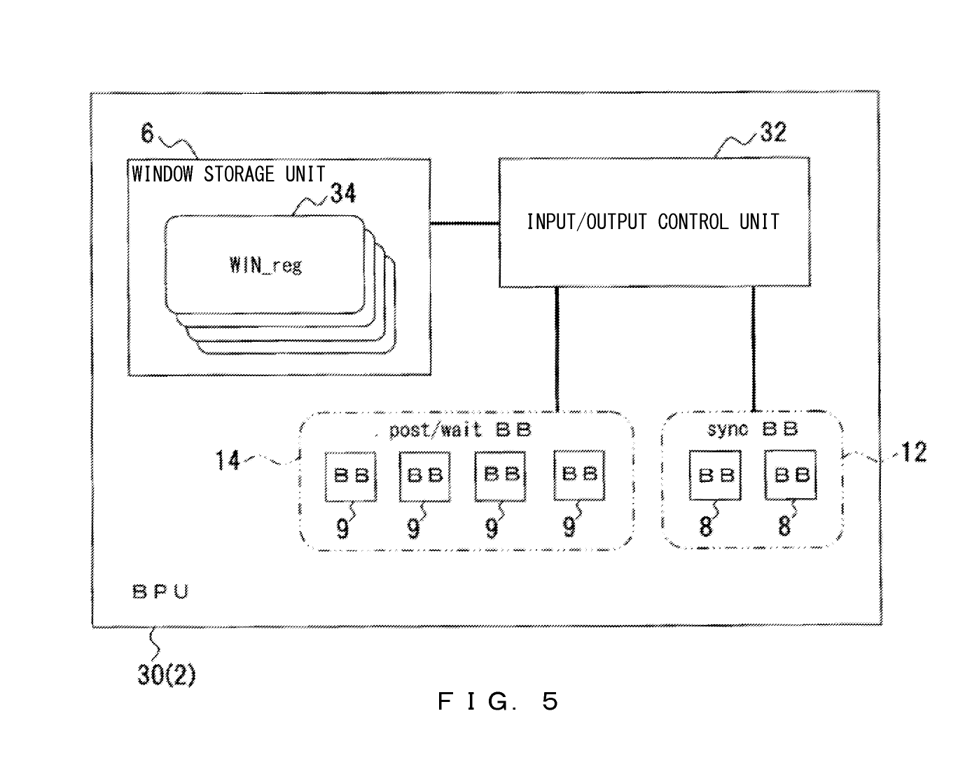

Next, regarding the barrier processing unit 30, FIG. 5 is referred to FIG. 5 illustrates the configuration of the barrier processing unit 30. The configuration illustrated in FIG. 5 is an example, and the present invention is not limited to such a configuration.

The barrier processing unit 30 illustrated in FIG. 5 includes the BB 8 being the first barrier blade categorized into the syncBB group 12, the BB9 being the second barrier blade categorized into the p/wBB group 14, and an input/output control unit 32. The BBs 8, 9 are for grouping the respective barriers into the synchronization group, and store the status of the synchronization group. The BBs 8, 9 may be categorized by such purposes. In this case, the BB 8 belongs to the syncBB group 12 used for synchronization of a plurality of cores 22, and the BB 9 belongs to the p/wBB group 14 used for synchronization of a plurality of cores 22.

The window storage unit 6 is resource to store which of the BBs 8, 9 being the barrier synchronization resource for each window (ASI address) set for each core 22, and is resource for assigning one of the BBs 8, 9 by software. In this window storage unit 6, a plurality of window registers (WIN_reg) 34 corresponding individually to the respective windows of the respective cores 22. This WIN_reg 34 is a storage means to store status information of the BBs 8, 9, that is, a barrier blade identification information holding unit, and corresponds to the storage unit 10 described above. The WIN_reg 34 holds, as the barrier blade identification information holding unit, barrier blade identification information to identify a plurality of barrier blades corresponding to a plurality of cores. the information described above stored in the WIN_reg 34 is information representing the synchronization status between a plurality of cores or one-to-one cores, barrier blade identification information to identify the BB 8 or BB 9. By the assignment of the BB number to specify each BB 8 or BB 9, the usage of barrier synchronization, and the writing into the registers in the BBs 8, 9, a (BST (Barrier Status bit)) mask bit register 36, a BST register 38 by each BB becomes available.

The input/output control unit 32 is an example of a barrier blade identification information selection unit that selects barrier blade identification information corresponding to input synchronization address identification information. That is, when synchronization address identification information is input, the input/output control unit 32 as the barrier blade identification information selection unit selects and outputs barrier blade identification information corresponding to the input synchronization address identification information, in the barrier blade identification information held be the window storage unit 6 as the barrier blade identification information storage unit.

Meanwhile, in the BBU 30 illustrated in FIG. 5, while the connection lines 20, 21 (FIG. 1) are not clearly illustrated, each WIN_reg 34 is connected to the BB 8 of the syncBB group 12, the BB 9 of the p/wBB group 14 by the connection line 20 or the connection lien 21, in the same manner as the barrier processing unit 2 illustrated in FIG. 1.

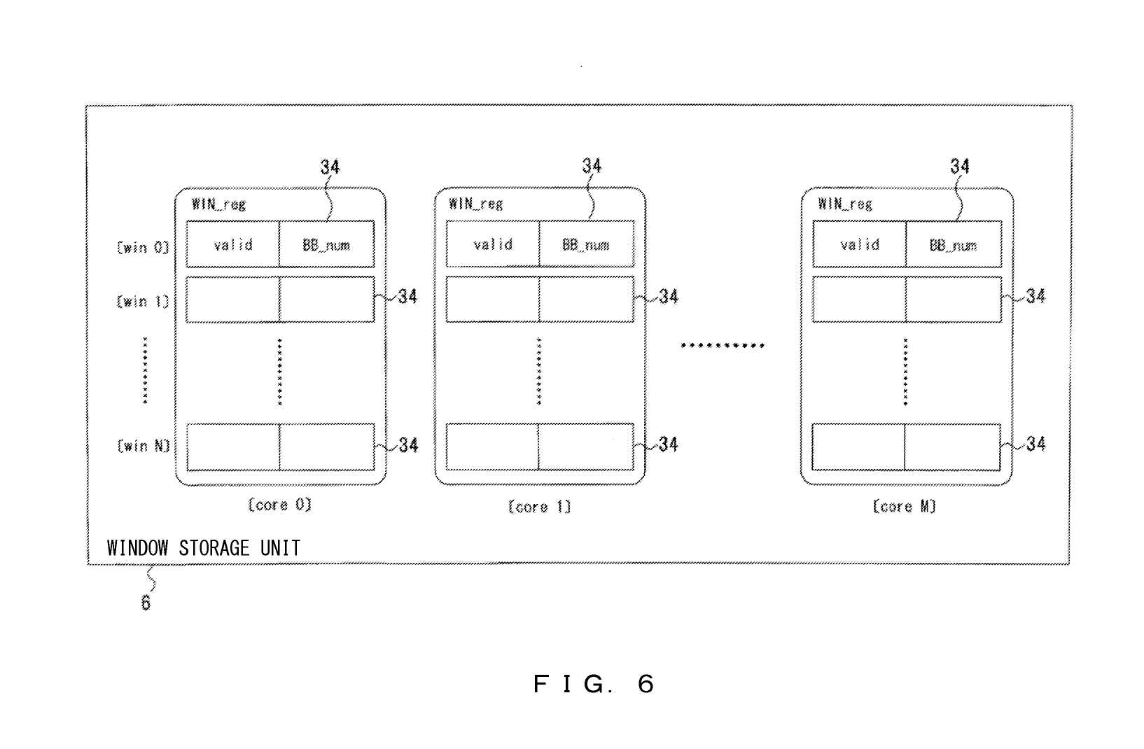

Next, regarding the configuration of the window storage unit 6, FIG. 6 is referred to. FIG. 6 illustrates the register configuration of the window storage unit.

The window storage unit 6 illustrated in FIG. 6 is equipped with a plurality of WIN_regs 34 connected to the BB 8 or the BB 9 using the connection line 20 or the connection line 21 (FIG. 1) described above. Each WIN_reg 34 is provided for a plurality of cores 22 and each window (ASI address) set for each core 22. That is, the WIN_reg 34 illustrated in FIG. 6 constitutes a register group grouped for each core 22, and the number of the WIN_reg 34 provided is the product of the number of cores and the number of windows, but may also be greater than that. Each WIN_reg 34 stores a BB number BB_num that represents the BB 8 or the BB 9 assigned to the window and valid as information that represents whether the BB number BB_num is valid.

Each win 0, win 1, . . . , win N assigned to the WIN_reg 34 is a window number that identifies the window set for each core 22, and the window may be identified by the window number. Meanwhile, core 0, core 1, . . . core M assigned while grouping the plurality of WIN_regs 34 are the core number assigned to each core 22, and the core 22 may be identified by the core number. According to such a configuration, the window storage unit 6 constitutes a conversion table between the window number and the BB number.

Using the window storage unit 6 described above, for example, by the core number 0 and the window number win 0, the WIN_reg 34 is identified. When the WIN_reg 34 is identified, the BB_num being the BB number assigned to a certain window and whether or not the BB_num assigned to the certain window is valid.

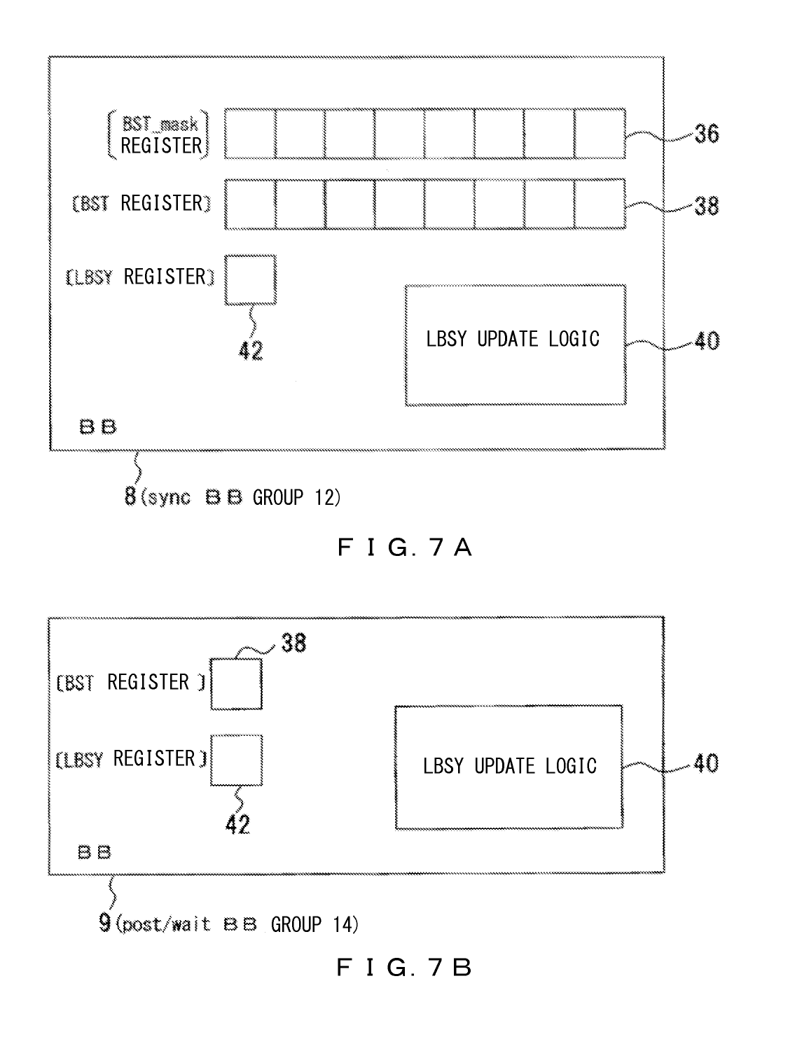

Next, regarding the internal configuration of the BBs 8, 9, FIGS. 7A and 7B are referred to. FIG. 7A illustrates the internal configuration of the BB 8. FIG. 7B illustrates the internal configuration of BB 9.

The BB 8 illustrated in FIG. 7A is the BB for synchronization between a plurality of cores, and includes a BST (Barrier Status bit) mask bit (BST_mask) register 36, a BST register 38, an LBSY update logic 40, an LBSY (Last Barrier SYnchronization status) register 42. The BST mask bit register 36 and the BST register 38 are, for example 8-bit length each, and have a fixed correspondence relationship with each core 22. The LBSY register 42 stores the value at the time of the last synchronization (details are described later).

The BB 9 illustrated in FIG. 7B is the BB for synchronization between two cores, and includes the BST register 38, the LBSY register 42 and the LBSY update logic 40.

According to the configuration of the BBs 8, 9 described above, synchronization is established when the bits selected in the BST_mask register 36, that is, the selected bits of the BST register 38 are all aligned to either “0” or “1”. When this synchronization is established, the aligned value “0” or “1” is copied to the LBSY register 42 using the LBSY update logic 40. Since the establishment of synchronization and the copy to the LBSY register 42 are executed in a single process, before the establishment of synchronization, the old value before the establishment of synchronization, that is, the value at the time of the last synchronization is stored in the LBSY register 42, and after the establishment of synchronization, the updated value is stored in the LBSY register 42.

Therefore, the procedure of the software to establish synchronization is, reading out of the value of the LBSY register 42, updating of the BST register 38, and after that, waiting for the change of the value of the LBSY register 42.

The BB monitors the value of the LBSY register 42, and when the value changes, makes the core 22 in the idle status recover to the execution status by a sleep instruction. Accordingly, achievement of both the fast-speed synchronization and effective utilization of the resource of the processor 4 becomes possible.

Since the LBSY register 42 stores the value at the last time when synchronization was established, the software is able to easily determine the value to set to the BST register 38 at the next synchronization. That is, when the value stored in the LBSY register 42 is “0”, “1” may be set to the BST register 38, and when the value stored in the LBSY register 42 is “1”, “0” may be written into the BST register 38.

Therefore, for each core 22, a plurality of windows used for barrier synchronization are set, and while each window corresponds to the BB 8 or the BB 9, the user program does not need to access directly to the BBs 8, 9, and accesses the window storage unit 6 via the window (ASI address). As described above, the BB 8, 9 assigned to each window is physically fixed. Then, the BST bit map is hidden and is fixed to the single operation of window specification, an operation that would cause destruction of synchronization may be avoided.

The window storage unit 6 stores which BB 8, 9 has been assigned for each window (ASI address) of each core 22. When the BB 8 or BB 9 is assigned to the window, barrier synchronization becomes available, and writing into the BST register 38 becomes available.

When the process of synchronization control ends, the value stored in the BST register 38 assigned to the corresponding window is reversed, and when the values of the valid BST register 38 (that is, set on the BST . . . mask register 36) are all aligned, the LBSY register 42 is also changed to the same value as the BST register 38. To each core 22, upon the reversing of the value of the LBSY register 42, a notification of the process completion of barrier synchronization is sent.

Meanwhile, in this barrier synchronization control, since the assignment of the BBs 8, 9 to the window is set to a privileged level at which the program operating at the user level is not able to write in, and writing into the BST register 38 is set to a unprivileged level at which the program operating at the user level is able to write in, access from the program operating at the user level to an irrelevant synchronization group causing a status destruction is prevented.

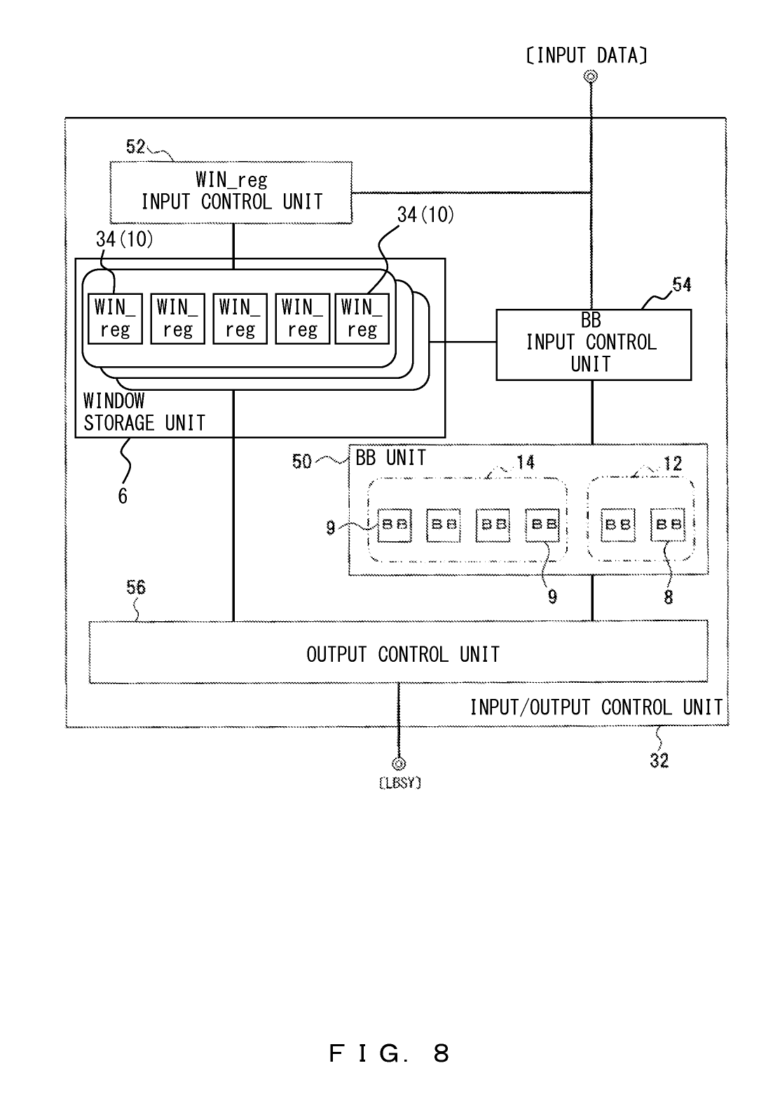

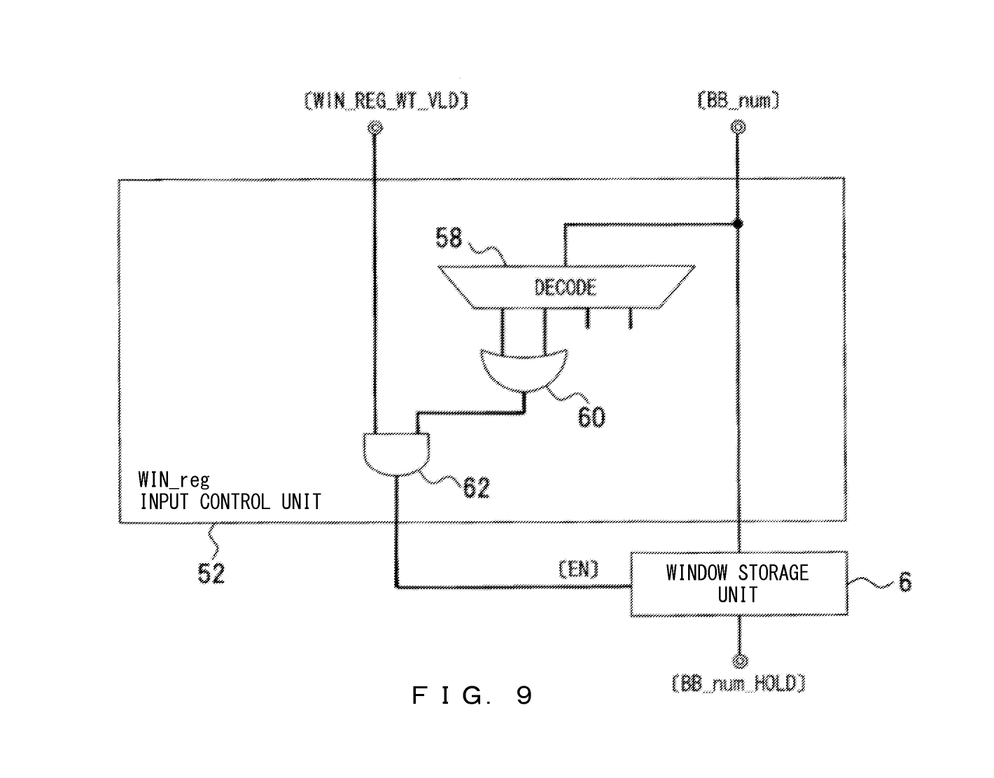

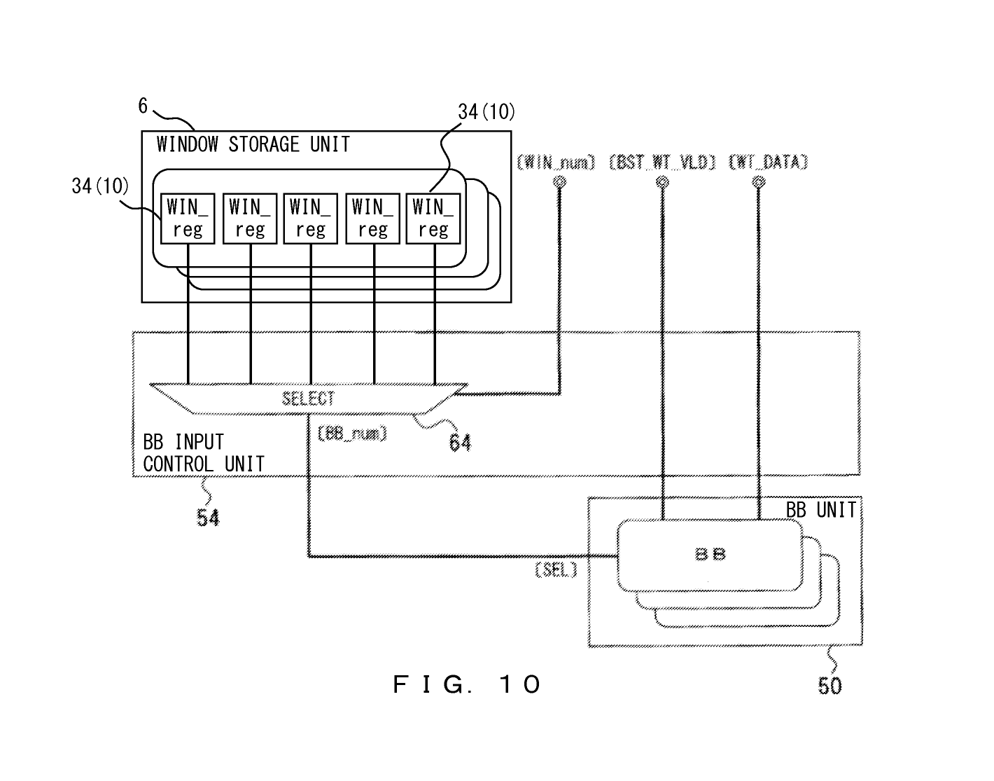

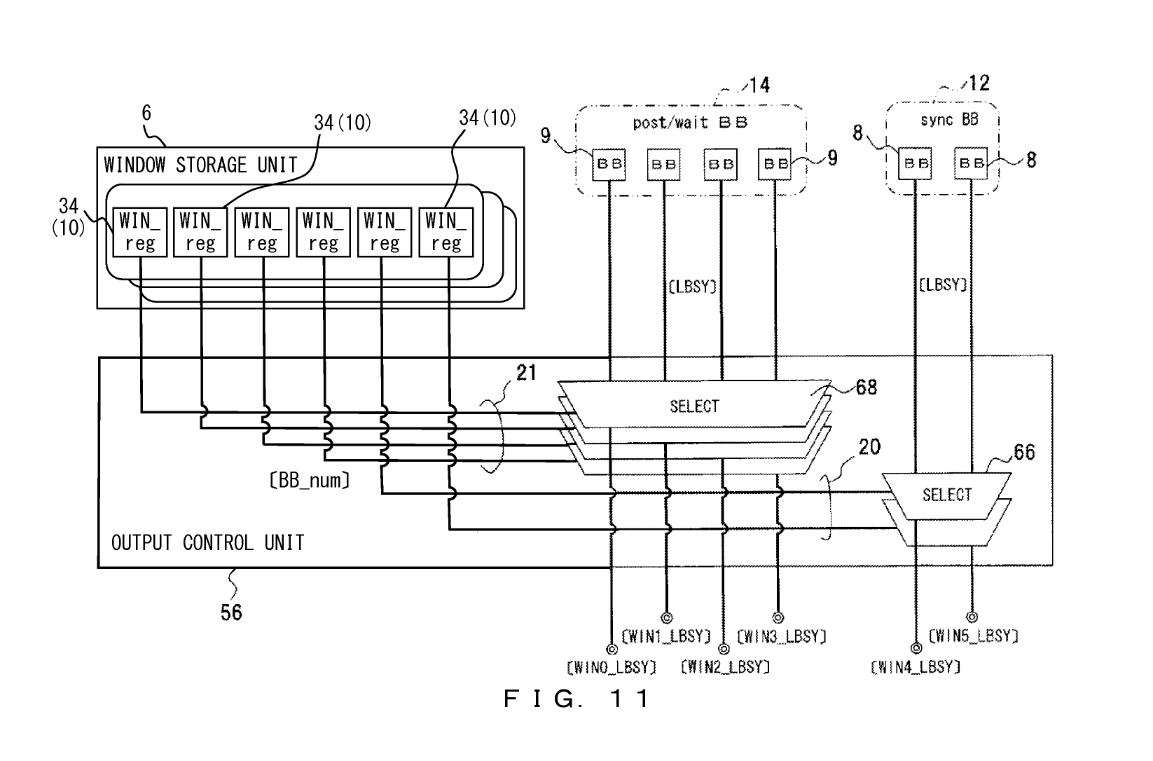

Next, regarding the input/output control unit 32, FIG. 8, FIG. 9, FIG. 10 and FIG. 11 are referred to. FIG. 8 illustrates the hardware configuration of the input/output control unit 32. FIG. 9 illustrates a window register (WIN_reg) input control unit 52 of the input/output control unit 32. FIG. 10 illustrates a BB input control unit 54 of the input/output control unit 32. In addition, FIG. 11 illustrates an output control unit 56 of the input/output control unit 32. In FIG. 8, FIG. 9, FIG. 10 and FIG. 11, the same numerals are assigned to the same parts as those in FIG. 4.

The input/output control unit 32 illustrated in FIG. 8 is, as described above, an example of the barrier blade identification information selection unit. The input/output control unit 32 identifies the BB 8, 9 to which a window (synchronization address) is assigned by the BB number in the window storage unit 6, and outputs the status information identified by the BB number as barrier blade identification information associated with the window number.

The input/output control unit 32 is equipped with the window register input control unit 52, the BB input control unit 54 and the output control unit 56. In FIG. 8, for the convenience of explanation, the window storage unit 6 mentioned above and a BB unit 50 are described inside the input/output control unit 32, but the input/output control unit 32 is different from the window storage unit 6 and the BB unit 50. Meanwhile, the BB unit 50 is barrier synchronization resource representing both the plurality of BBs 8, 9 collectively.

The input data added to the WIN_reg input control unit 52 and the BB input control unit 54 include a write instruction and the BB number and the like. In the WIN_reg input control unit 52, the WIN_reg 34 in the window storage unit 6 is selected, and together with the BB number read out from the WIN_reg 34, valid information indicating whether the value is valid is added to the BB input control unit 54. In the BB input control unit 54, from the window number, the BBs 8, 9 assigned to the window are selected, and the status information from the output of the BBs 8, 9 and the WIN_reg 34 is added to the output control unit 56. As a result, from the output control unit 56, LBSY output associated with the window number is taken out, and its notification is sent to each core 22. That is, the output control unit 56 is an example of the status information selection unit, and based on barrier blade identification information that the WIN_reg input control unit 52 selected, outputs one of a plurality of pieces of status information indicating a plurality of cores being synchronized, output from a plurality of barrier blades, that is, BBs 8, 9.

Therefore, the status information of the BB 8, 9 is converted into the LBSY information associated with the window number by the BB number and is output.

In the input/output control unit 32, the WIN_reg input control unit 52 is a means to execute writing control into the window storage unit 6, and includes, for example, in the configuration illustrated in FIG. 9, a decoder 58, an OR circuit 60 and an AND circuit 62.

In the WIN_reg input control unit 52, when a window write instruction WIN_REG_WT_VLD with regard to the WIN_reg 34 (FIG. 8) of the window storage unit 6 is given, the window write instruction WIN_REG_WT_VLD becomes one of inputs of the AND circuit 62. The window write instruction WIN_REG_WT_VLD is an information signal representing the writing of the BB number into the window storage unit 6 is valid. When the BB number BB_num is input together with the window write instruction WIN_REG_WT_VLD, the BB number BB_num is input to the window storage unit 6 and the decoder 58. The decoder 58 decodes the BB number BB_num into, for example, 4-bit data. The logical sum of the output 2 bits of the decoder 58 is obtained by the OR circuit 60, and the output of the OR circuit 60 becomes the other of the inputs of the AND circuit 62.

The AND circuit 62 constitutes a judgment unit as to whether or not to write into the window storage unit 6, and when the AND condition is satisfied in the AND circuit 62, the output of the AND circuit 62 is input as a write enable signal EN into the window storage unit 6. Accordingly, the BB number is written into the WIN_reg 34 set for a prescribed core 22 of the window storage unit 6. Therefore, the BB 8 or BB 9 is assigned to the window set for the core 22. Then, the BB number stored in the window storage unit 6 is read out as a hold BB number BB_num_HOLD.'

In the input/output control unit 32, the BB input control unit 54 is used for controlling input to the BB unit 50, and for example, as illustrated in FIG. 10, includes a select circuit 64.

For BST writing control, a window number WIN_num, BST write instruction BST_WT_VLD and write data WT_DAT are given from the software of the OS (Operating System) and the like. The window number WIN_num is input to the select circuit 64, and the BB number BB_num in the WIN_reg 34 of the window storage unit 6 is selected, and is added to the BB unit 50 as selection information SEL. That is, the BB 8, 9 assigned to the window is selected. To the selected BB 8 or BB 9, based on the BST write instruction BST_WT_VLD, write data WT_DAT is written.

Then, the output control unit 56 constitutes an LBSY select circuit as a conversion means of LBSY information, as illustrated in FIG. 11.

The output control unit 56 illustrated in FIG. 11 includes a select circuit 66 as a first selection means, and a plurality of select circuits 68 as a second selection means.

Each select circuit 66 corresponds to each BB 8 of the syncBB group 12, and also corresponds to a window to which each BB 8 may be assigned. Meanwhile, the select circuit 68 corresponds to each BB 9 of the Post/WaitBB group 14, and also corresponds to a window to which each BB 9 may be assigned. These select circuits 66, 68 are set for each core 22 in the same manner as the window storage unit 6.

In order to realize such a correspondence relationship, the select circuit 66 is connected between each BB 8 of the syncBB group 12 and the plurality of WIN_regs 34 of the window storage unit 6 in the corresponding relationship using the first connection line 20. Meanwhile, the select circuit 68 is connected between each BB 9 of the Post/WaitBB group 14 and the plurality of WIN_regs 34 of the window storage unit 6 using the second connection line 21.

According to such a configuration, input of BST information and output of LBSY information are executed.

a) In the storage process of the window storage unit 6, the BB number specified by the window number is stored for each window number.

b) When inputting the BST information, based on the specification of the window number, the BST information is written into the corresponding BB 8 and BB 9 by being converted into the BB number.

c) When outputting the LBSY information, the LBSY information is converted into the window number for each BB 8 or BB 9, and the LBSY information is transmitted to the core 22 while associating it with the window number.

In the embodiment, the LBSY information of each BB 9 is converted by the select circuit 68, and is taken out as window status information WINO-LBSY, WIN1-LBSY, . . . , WINS-LBSY. Meanwhile, the LBSY information of each BB 9 of the Post/WaitBB group 14 is converted by the select circuit 66 and is taken out as window status information WIN4-LBSY, WIN5-LBSY. Each LBSY is the value at the time of last synchronization, and this LBSY is sent to the core 22 of the processor 4.

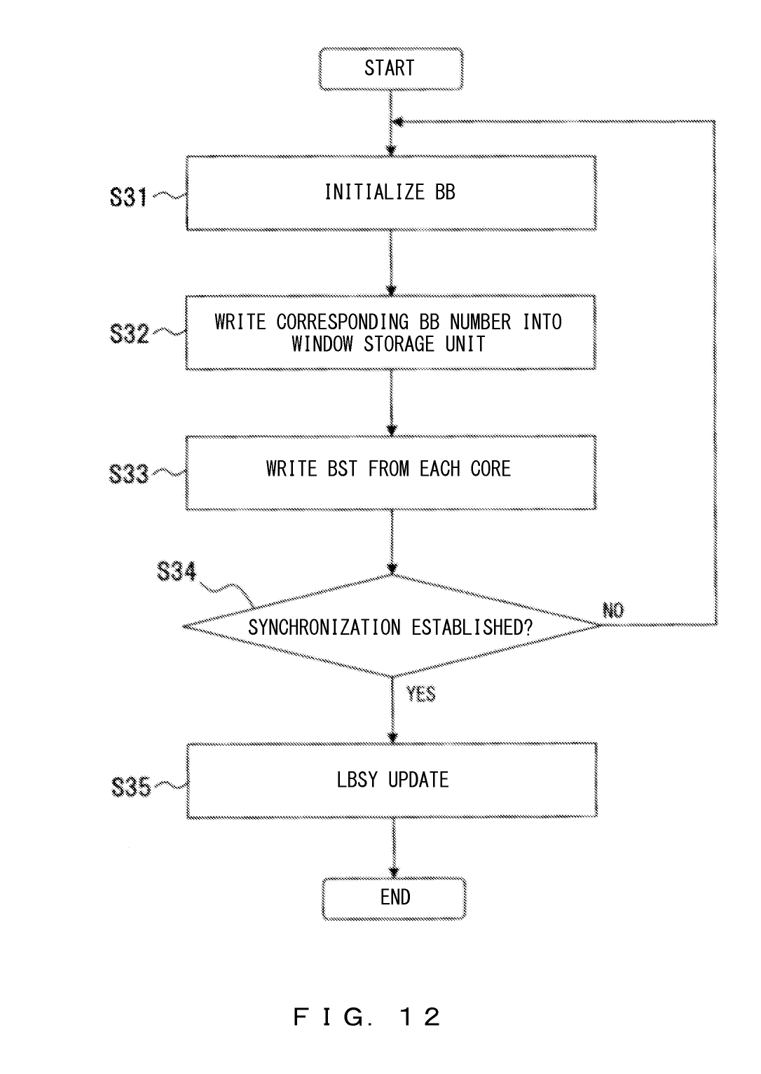

Next, regarding barrier synchronization control, FIG. 12 is referred to FIG. 12 illustrates the process procedure of batter synchronization control.

In the barrier synchronization control illustrated in FIG. 12, initialization of the BBs 8, 9 is performed by the software (step S31), and writing of the BB number corresponding to the WIN_reg 34 of the window storage unit 6 is performed (step S32). By this writing, writing from each core 22 into the BST register 38 is performed (step S33), and whether or not synchronization is established is monitored.

When the values of the BST register 38 all become the same value, synchronization is established (step S34), and the value of the LBSY register is updated (step S35) , and the barrier synchronization control is terminated.

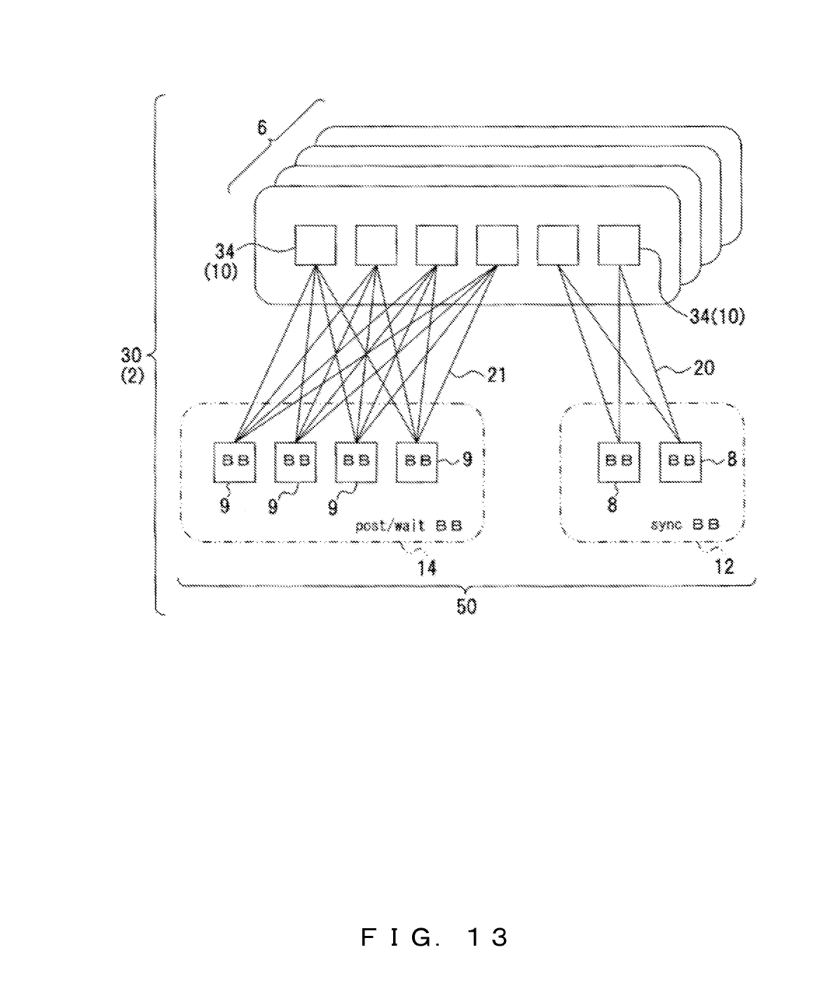

Next, regarding the physical resource of the barrier processing unit 30, FIG. 13 is referred to. FIG. 13 illustrates the configuration example of the barrier processing unit 30.

The barrier processing unit 30 illustrated in FIG. 13 corresponds to the barrier processing unit 30 (FIG. 5) described earlier, and illustrates the part of the output control unit 56 (FIG. 11) in a summarized manner. This configuration example illustrates the BB 8 and the BB 9 grouped in the range in which assignment to each window is possible.

In the barrier processing unit 30, the window storage unit 6 has the WIN_regs 34 being a plurality of barrier blade identification information holding units that hold barrier blade identification information to identify the plurality of BBs 8, 9, in correspondence with the cores being a plurality of arithmetic processing units.

Each of the BBs 8 belonging to the group 12 of the first barrier blade is connected to, among the plurality of WIN_regs 34, the WIN_reg 34 that holds barrier blade identification information of a plurality of cores to perform synchronization by the connection line 20.

Each of the BBs 8 belonging to the group 14 of the second barrier blade is connected to, among the plurality of WIN_regs 34, the WIN_reg 34 that holds barrier blade identification information of two cores to perform the synchronization by the connection line 21.

In the configuration example illustrated in FIG. 13, a case with four cores 22 (FIG. 4), six windows for each core 22, two BBs 8, four BBs 9 is assumed. In this configuration example, in order to simplify the explanation, only one core 22 is described, but if the actual configuration is described, the number of connections of the connection lines 20, 21 that are able to assign each BB 8, 9 to all the windows of all the cores 22 is quadruple.

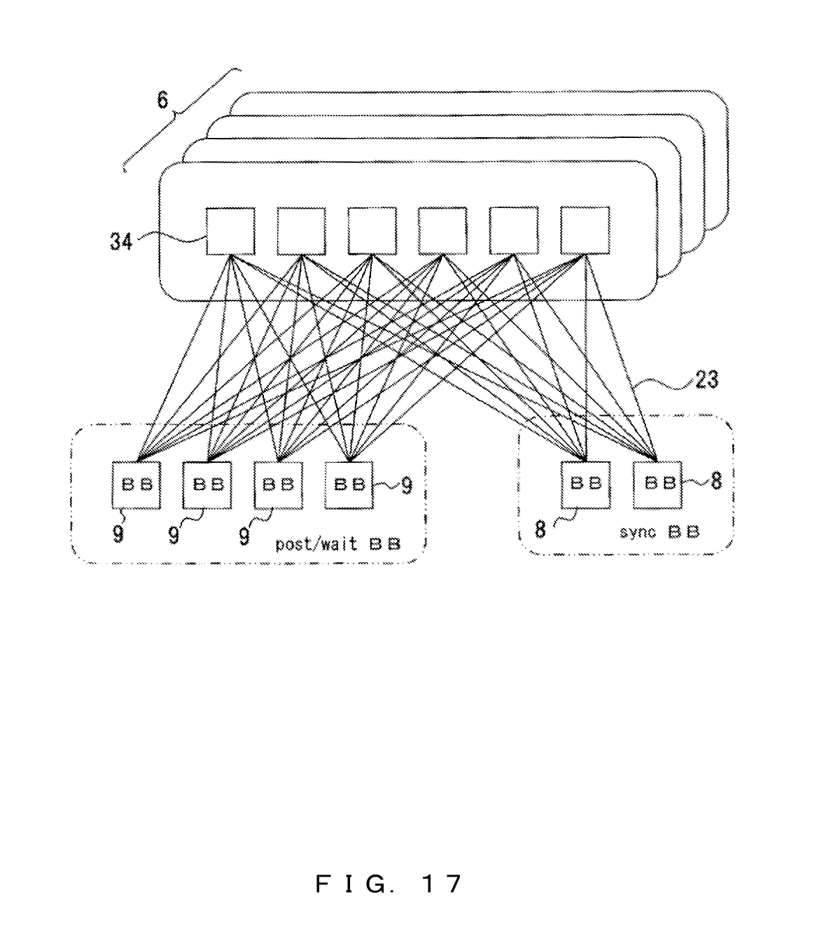

In such a configuration, the BBs 8, 9 that may be assigned to each window used for barrier synchronization are categorized by purpose, and according to the purpose, the window to which assignment is available is limited, significantly reducing the number of connections of the physical connection lines 20, 21. That is, it is reduced to half of that in the comparison example (FIG. 17). While the actual reduction effect depends on the number of windows and the number of BBs, since the required number of windows, number of BBs increases according to the increase in the number of cores, the amount of reduction increases. In this case, the amount of reduction of the physical resource is,

(The amount of reduction)=(the reduction effect per core)×(the number of cores) (3).

Since each core has the window used for barrier synchronization, and the number of windows increases according of the increase in the cores, when the number of cores increases, the amount of reduction of the physical resource increases exponentially.

Then, for the assignment of the BBs 8, 9 to the window, there is no degree of freedom at the user side, and there is no influence on barrier synchronization executed by the user. That is, while there are accessable ones and inaccessible ones depending on authority, in the barrier, execution is not allowed without authority (OS) up to the BB initialization, assignment, and the user is able to execute BST_WT only. Therefore, by performing setting in consideration of the assignable range at the time of assignment, the number of resource itself is unchanged from the past, and the influence from the user's viewpoint is none. That is, since there is no change in the number of resource such as the window and the BBs 8, 9, the barrier synchronization function is not hindered. Therefore, according to the configuration described above, the physical resource is reduced without hindering the barrier synchronization function.

Regarding the second embodiment, characteristics, advantages and variation examples are listed below.

(1) Barrier synchronization control between the cores 22 inside the processor 4 may be realized, and the distributed processing is realized in units of the processor 4, contributing to the speeding up of the processing speed and the expansion of the processing capacity.

(2) Since the settable value of the BB number is limited by the window, the LBSY of the BB 8 or BB 9 not selected may be excluded from the selection target. Accordingly, together with the speeding up of the synchronization control of barrier control, the amount of physical resource may be reduced. That is, the number of select circuits and the number of connection lines as physical resource may be reduced.

(3) Since the amount of physical resource provided in the processor 4 may be reduced, the amount of physical resource with respect to the increase in the number of cores may be curbed.

(4) Since the physical resource may be reduced, from the viewpoint of the same amount of physical resource, the proportion in the chip occupied by the BPU 30 may be reduced, and the usage efficiency within the chip may be increased by that amount.

(5) While LBSY is sent to each core 22, there is no direct transmission from the BBs 8, 9, and may be regarded as output from the set window.

(6) Since the BB number written in the WIN_reg 34 of the window storage unit 6 is used, which BB 8, 9 is assigned to each window may be judged from the BB number, and LBSY may be selected in association with the window number converted from the BB number.

(7) Since all the BBs are set for all the windows, all the BBs become the select target, but in this embodiment, the settable value of the BB number is limited according to the window, and LBSY information of the BBs 8, 9 that do not exit as a choice may be excluded from the select target. Accordingly the physical resource is reduced and the speed of processing is increased.

(8) In barrier synchronization control to realize barrier synchronization inside the processor 4 including a plurality of cores 22, by categorizing the specification available range of the window used for barrier synchronization by the type of the BBs 8, 9, the physical resource may be reduced.

(9) One of the categorized BB 8 or BB 9 is assigned in a fixed manner to an arbitrary window. In contrast, in a configuration in which the BB 8 or the BB 9 is assigned without distinction, while a high degree of freedom is given to the assignment, when the increase in the number of cores increases, in addition to the increase in the physical resource, by the increase in the number of BBs and the windows used for barrier synchronization, the physical resource per core increases. Such inconvenience may be resolved by the embodiment described above. Moreover, the exponential increase of the physical resource of the selector used for window control may be prevented, and the occupation of the area of the physical resource in the LSI on which the processor 4 is mounted may be prevented, making it possible to curb the increase in the power consumption.

(10) The barrier processing unit 30 includes a conversion means to perform rewrite between the window number and the BB number. In this conversion means, a conversion unit that converts from the window number to the BB number at the time of BST_WT, and a conversion unit that converts LBSY information from each BB 8, 9 into the window number and outputs it to each core 22 exist. Of these conversion units, in the latter conversion unit, the physical resource that converts LBSY information from each BB 8, 9 into the window number and outputs it to each core 22 is significantly reduced.

(11) Which of the BBs 8, 9 to be assigned to each window of each core 22 is set by writing by the software. As hardware, a plurality of WIN_regs 34 that stores the BB number corresponding to the number of cores×the number of windows information valid indicating whether or not the value is valid are provided. Using the BB number written in each WIN_reg 34, the conversion between the BB number and the window number is performed, and LBSY information may be output to the core 22.

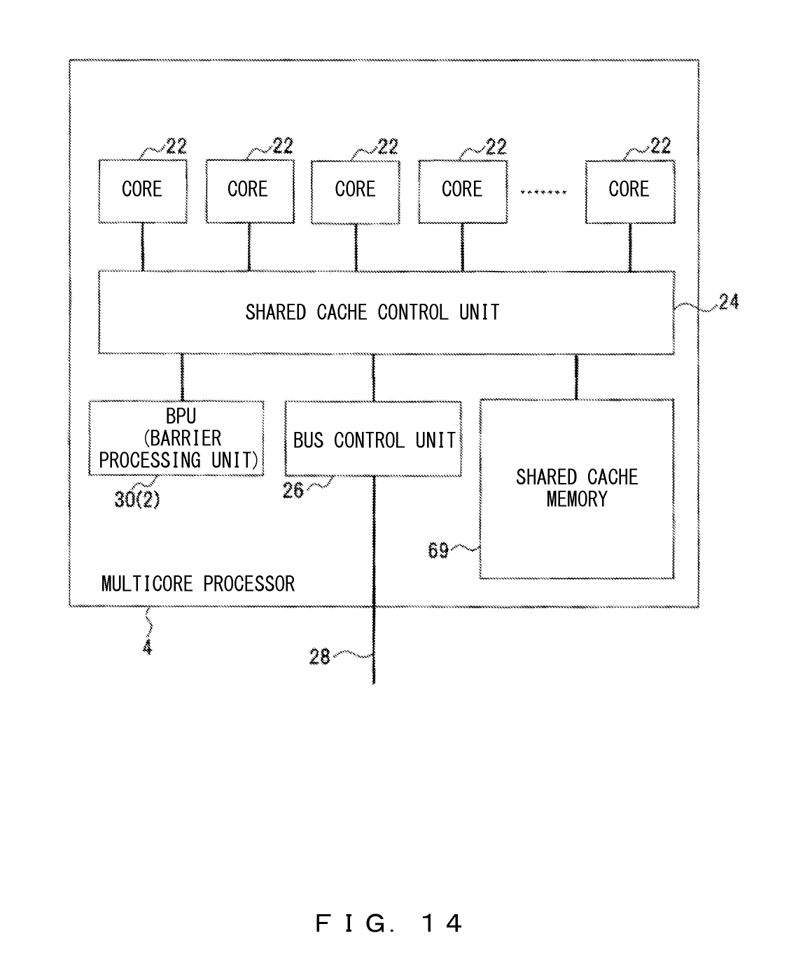

(12) The process 4 in the embodiment described above many also be configured so that, as illustrated in FIG. 14, a shared cache memory 69 in the processor 4 is provided, and data used between the respective cores 22 is cached.

### Third Embodiment

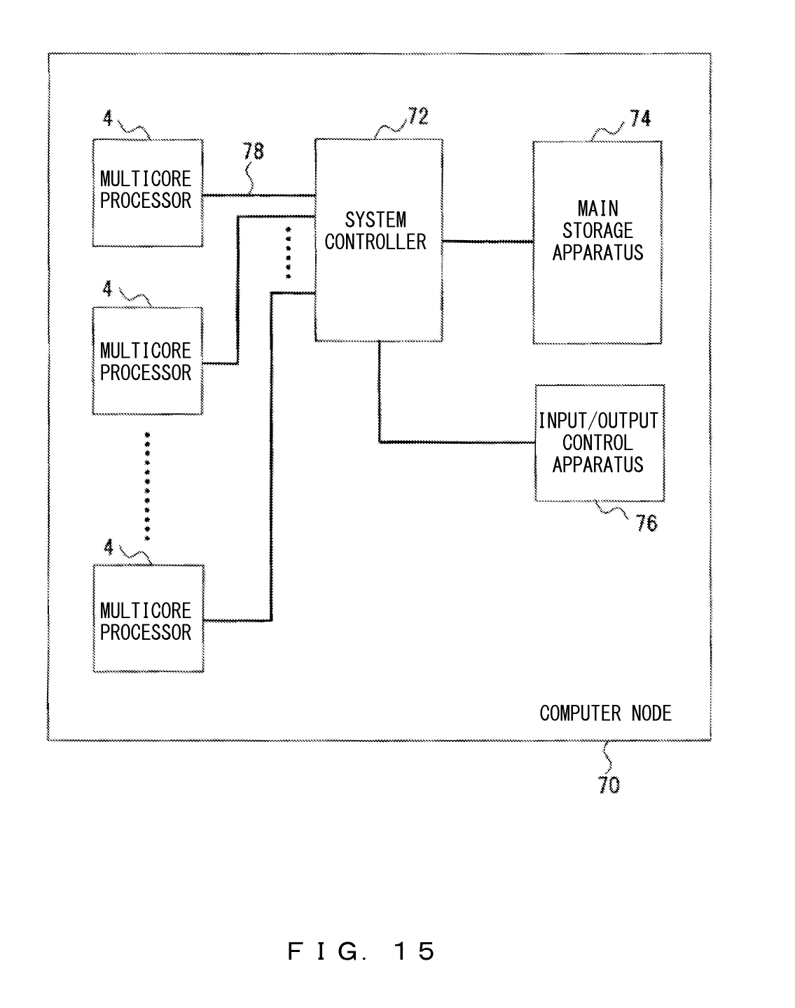

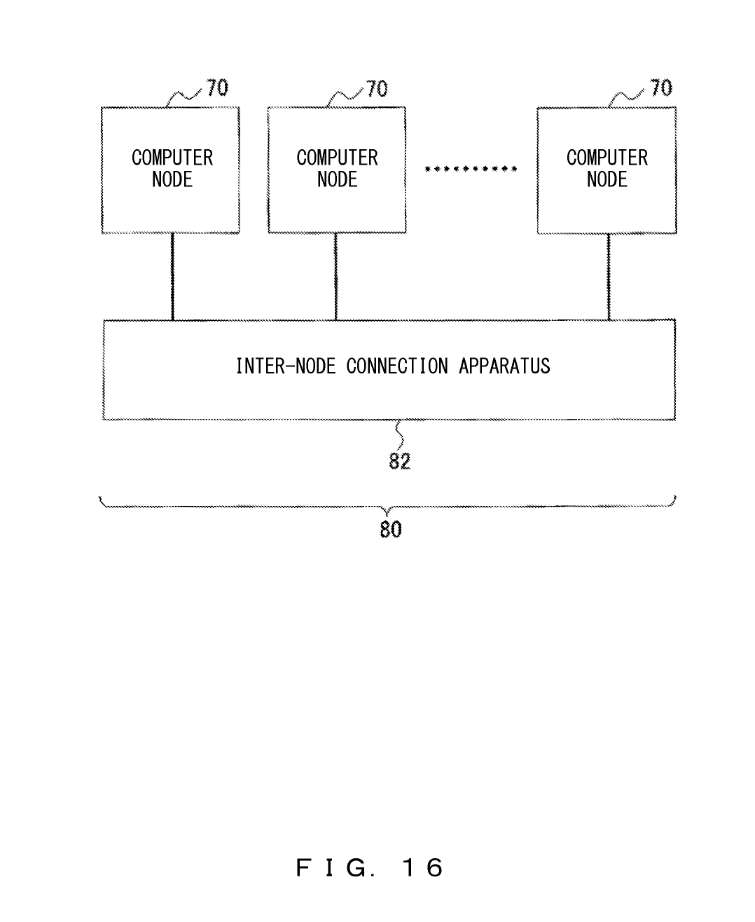

Regarding the third embodiment, FIG. 15 and FIG. 16 are referred to. FIG. 15 illustrates a computer node using the processor 4 including the barrier processing unit 30 described earlier. FIG. 16 illustrates a configuration example of a computer system.

The computer node 70 illustrated in FIG. 15 is an example of an information processing apparatus, and includes a plurality of processors 4, a system controller 72, a main storage apparatus 74 and an input/output control apparatus 76. The barrier processing unit 30 described earlier is mounted on each processor 4. The system controller 72 is connected to each processor 4 by a bus 78. To the system controller 72, the main storage apparatus 74 shared among the respective processors 4 is connected, and there may also be a case in which an external storage apparatus not illustrated in the drawing is connected. To the system controller 72, the input/output control apparatus 76 used for data input/output are connected, and by the input/output control apparatus 76, data input/output is performed between each processor 4 and the main storage apparatus 74.

Then, in the computer system 80 illustrated in FIG. 16, a plurality of computer nodes 70 are provided. A plurality of processors 4 described above are mounted on each computer node 70. The respective computer nodes 70 are connected via an inter-node connection apparatus 82, and distributed processing is available.

In such a configuration, the barrier processing unit 30 described earlier is provided in each processor 4 and barrier synchronization is realized, and by providing the configuration of the embodiment described above, the increase and expansion of the quantitative resource due to the increase in the number of cores of each processor may be curbed. Therefore, contribution to the speeding up and expansion of the capacity of processing required for the computer system 80 is possible.

### Other Embodiments

(1) In the embodiments described above, barrier synchronization between a plurality of cores 22 of the processor 4 is described, but this is not a limitation. The barrier synchronization method or the barrier synchronization apparatus disclosed herein may also be used for barrier synchronization between a plurality of processors 4,

(2) In the embodiments described above, the BB being the barrier blade is categorized into the BB 8 and the BB 9 according to the purpose, but this is not a limitation. While the categorization by purpose is beneficial, categorization of internal configuration, specification, characteristics and the like may also be used.

### COMPARISON EXAMPLE

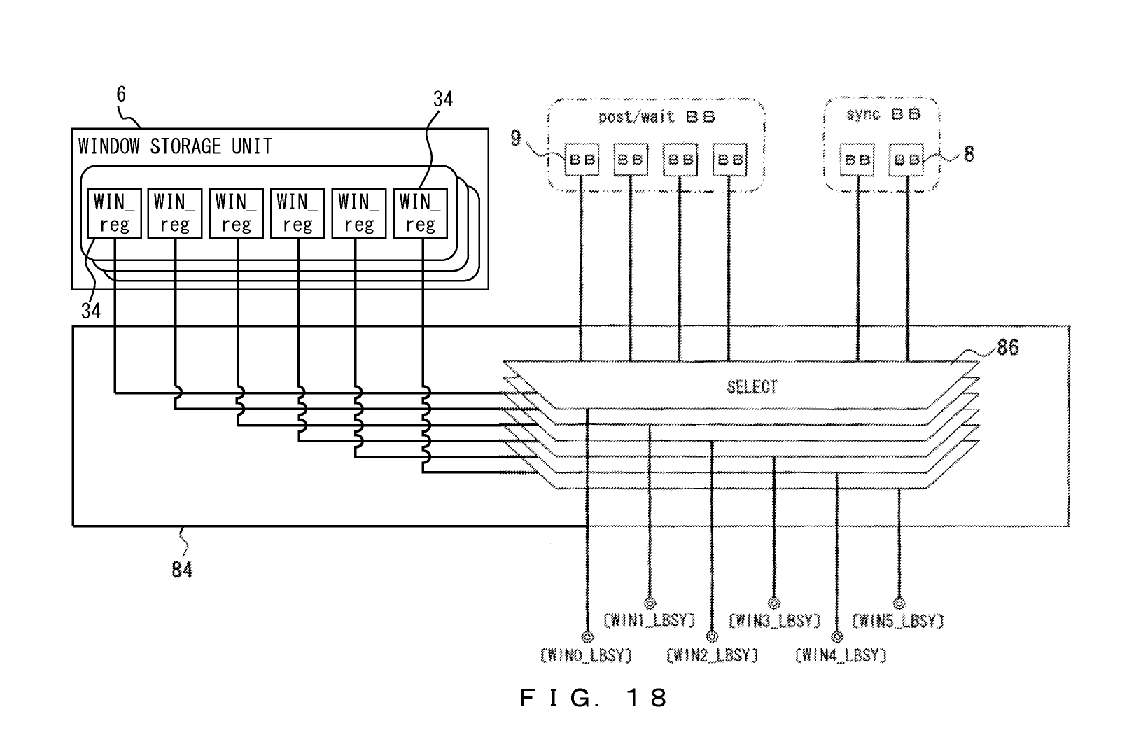

This comparison example is a case in which all the BBs are set for all the windows. Regarding the comparison example, FIG. 17 and FIG. 18 are referred to. FIG. 17 illustrates the available range of window assignment. FIG. 18 illustrates an LBSY select circuit example.

In the comparison example, four cores 22, six windows for each core 22 in the processor 4 is assumed. In addition, as the syncBB used for barrier synchronization, two BBs 8, and four BBs 9 as the BB for Post/Wait are provided.

In such a configuration, the BB 8, 9 and each WIN_reg of each window storage unit 6 are connected using a connection line 23 without distinction of all the BBs 8, 9. In this comparison example as well, in order to simplify the explanation, description is for one core 22, and in this comparison example, an arbitrary BB 8, 9 maybe assigned freely to an arbitrary window. For this reason, the number of connections between all the windows of all the cores 22 and the BBs 8, 9 is quadrupled according to the number of cores.

For barrier synchronization control of this comparison example, an LBSY select circuit 84 illustrated in FIG. 18 is used. IN the LBSY select circuit 84, the window number BB_num stored in a plurality of WIN_regs 34 in the window storage unit 6 is input to a select circuit 86. To the select circuit 86, LBSY of each BB 8, 9 is input. As a result, from each select circuit 86, the respective window status information WIN0-LBSY, WIN1-LBSY, . . . WIN5-LBSY is output.

In the comparison example, the amount of physical resource such as the selector used for barrier synchronization control is,

the amount of physical resource=(the number of BB 8+the number of BB 9)×the number of windows×the number of cores (4)

As described above, since the amount of physical resource is the product of the number of cores, the number of windows and the number of BBs, it becomes a more enormous amount, as the number of cores increases.

That is, when the number of cores is increased, the number of windows also increases, and from the viewpoint of the entirety of the shared cache unit, the physical resource follows an increasing trend. Not only such increase in the physical resource, but also the power consumption increases, and the proportion occupied by the physical resource described above in the LSI on which the multicore processor is mounted also increases. Such an issue is solved by the embodiments described above.

While preferred embodiments and the like of the barrier synchronization method, the barrier synchronization apparatus and the multicore processor are explained as described above, the disclosure herein is not limited to the descriptions above, and it is obvious that various variations and changes may be made by persons skilled in the art, based on the gist of the invention described in the claims, or disclosed in the specifications, and it goes without saying that such variations and changes are included in the scope of the present invention.

### INDUSTRIAL APPLICABILITY

The barrier synchronization method, the barrier synchronization apparatus and the arithmetic processing apparatus disclosed herein are useful as they may be used for information processing including a plurality of processor cores and contribute to the speeding up and expansion of the capacity of processing.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment (s) of the present invention has (have) been described in detail, it should be understood that the various changes, substitutions, and alterations could be made hereto without departing from the spirit and scope of the invention.

What is claimed is:

1. A barrier synchronization method of an arithmetic processing apparatus comprising a plurality of arithmetic processing units, comprising:
synchronizing, by a plurality of barrier blades, the plurality of arithmetic processing units using a synchronization address set for the plurality of arithmetic processing units;
holding, by a barrier blade identification information storage unit, barrier blade identification information to identify the barrier blade corresponding to synchronization address identification information to identify the synchronization address, for each of the plurality of arithmetic processing units;
when synchronization address identification information is input, selecting and outputting, by a barrier blade identification information selection unit, barrier blade identification information corresponding to the input synchronization address identification information, among barrier blade identification information held by the barrier blade identification information storage unit.

2. The barrier synchronization method according to claim 1, wherein
based on the barrier blade identification information selected by the barrier blade identification information selection unit, a status information selection unit outputs one of a plurality of pieces of information representing that the plurality of arithmetic processing units have been synchronized, output by the plurality of barrier blade.

3. The barrier synchronization method according to claim 1, wherein
the plurality of barrier blades comprise a barrier blade belonging to a first barrier blade group used for synchronization between a plurality of the arithmetic processing units, and a barrier blade belonging to a second barrier blade group in the barrier blade identification information storage unit, used for synchronization of any two arithmetic processing units;
the barrier blade identification information storage unit applies grouping and holds the barrier blade identification information while applying grouping based on the barrier blade of each of the groups.

4. The barrier synchronization method according to claim 1, wherein
when assigning the barrier blade to the synchronization address set for the arithmetic processing unit, whether or not assignment is available is judged.

5. A barrier synchronization apparatus of an arithmetic processing apparatus comprising a plurality of arithmetic processing units, comprising:
a plurality of barrier blades configured to synchronize the plurality of arithmetic processing units using a synchronization address set for the plurality of arithmetic processing unit;
a barrier blade identification information storage unit configured to hold barrier blade identification information to identify the barrier blade corresponding to synchronization address identification information to identify the synchronization address, for each of the plurality of arithmetic processing units; and
a barrier blade identification information selection unit configured to, when synchronization address identification information is input, select and output barrier blade identification information corresponding to the input synchronization address identification information, among barrier blade identification information held by the barrier blade identification information storage unit.

6. The barrier synchronization apparatus according to claim 5, further comprising:
a status information selection unit configured to output, based on the barrier blade identification information selected by the barrier blade identification information selection unit, one of a plurality of pieces of information representing that the plurality of arithmetic processing units have been synchronized, output by the plurality of barrier blade.

7. The barrier synchronization apparatus according to claim 5, wherein
the plurality of barrier blades comprise a barrier blade belonging to a first barrier blade group used for synchronization between a plurality of the arithmetic processing units, and a barrier blade belonging to a second barrier blade group in the barrier blade identification information storage unit, used for synchronization of any two arithmetic processing units;
the barrier blade identification information storage unit applies grouping and holds the barrier blade identification information while applying grouping based on the barrier blade of each of the groups.

8. The barrier synchronization apparatus according to claim 7, wherein
the barrier blade identification information storage unit comprises a plurality of barrier blade identification information holding units configured to hold barrier blade identification information to identify the plurality of barrier blades, corresponding to the plurality of arithmetic processing units;
each barrier blade belonging to the first barrier blade group connects to a barrier blade identification information holding unit holding barrier blade identification information of a plurality of the arithmetic processing unit to synchronize, among the plurality of the barrier blade identification information holding units; and
each barrier blade belonging to the second barrier blade connects to a barrier blade identification information holding unit holding barrier blade identification information of two of the arithmetic processing units to synchronize.

9. An arithmetic processing apparatus comprising a plurality of arithmetic processing units, comprising:
a plurality of barrier blades configured to synchronize the plurality of arithmetic processing units using a synchronization address set for the plurality of arithmetic processing unit;
a barrier blade identification information storage unit configured to hold barrier blade identification information to identify the barrier blade corresponding to synchronization address identification information to identify the synchronization address, for each of the plurality of arithmetic processing units; and
a barrier blade identification information selection unit configured to, when synchronization address identification information is input, select and output barrier blade identification information corresponding to the input synchronization address identification information, among barrier blade identification information held by the barrier blade identification information storage unit.

10. The arithmetic processing apparatus according to claim 9, further comprising:
a status information selection unit configured to output, based on the barrier blade identification information selected by the barrier blade identification information selection unit, one of a plurality of pieces of information representing that the plurality of arithmetic processing units have been synchronized, output by the plurality of barrier blade.

11. The arithmetic processing apparatus according to claim 9, wherein
the plurality of barrier blades comprise a barrier blade belonging to a first barrier blade group used for synchronization between a plurality of the arithmetic processing units, and a barrier blade belonging to a second barrier blade group in the barrier blade identification information storage unit, used for synchronization of any two arithmetic processing units;
the barrier blade identification information storage unit applies grouping and holds the barrier blade identification information while applying grouping based on the barrier blade of each of the groups.

12. The arithmetic processing apparatus according to claim 11, wherein
the barrier blade identification information storage unit comprises a plurality of barrier blade identification information holding units configured to hold barrier blade identification information to identify the plurality of barrier blades, corresponding to the plurality of arithmetic processing units;
each barrier blade belonging to the first barrier blade group connects to a barrier blade identification information holding unit holding barrier blade identification information of a plurality of the arithmetic processing unit to synchronize, among the plurality of the barrier blade identification information holding units; and
each barrier blade belonging to the second barrier blade connects to a barrier blade identification information holding unit holding barrier blade identification information of two of the arithmetic processing units to synchronize.

13. The arithmetic processing apparatus according to claim 9, wherein
the barrier blade comprises either one of a storage unit configured to store status information representing a synchronization status of a plurality of the arithmetic processing units, or a storage unit configured to store status information representing a synchronization status of two the arithmetic processing units.

14. The arithmetic processing apparatus according to claim 10, wherein
the status information selection unit comprises a plurality of selection units configured to select synchronization information of the barrier blade in association with the synchronization address selected by referring to the identification information.

15. The arithmetic processing apparatus according to claim 9, wherein
a connection line is provided between the plurality of barrier blade and the barrier blade identification information storage unit distinguished in correspondence to synchronization address of the barrier blade.

16. The arithmetic processing apparatus according to claim 9, wherein
the arithmetic processing apparatus has a cache memory shared by the plurality of arithmetic processing units.

17. The arithmetic processing apparatus according to claim 9, wherein
the arithmetic processing apparatus is a processor in which the plurality of arithmetic processing units are mounted on an LSI.
